(19) United States
(12) Patent Application Publication
(10) Pub. No.: US 2007/0243734 A1
(43) Pub. Date: Oct. 18, 2007

(54) Mouse with direction-adjustable connecting wire

(76) Inventor: Yuan-Jung Chang, Hsin Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/402,969

(22) Filed: Apr. 13, 2006

(51) Int. Cl. H01R 13/62

(52) U.S. Cl. 439/157

(57) ABSTRACT

A mouse with direction-adjustable connecting wire that includes an housing, a connecting wire, and a wire-receiving groove. One end of the connecting wires embedded in the housing, the wire-receiving groove is entirely or partially surrounded around the housing, and the connecting wires contained in the wire-receiving groove and passed the housing from the wire-receiving groove. Hence, a direction-adjustable connecting wires designed to make the mouse is easily and conveniently operated so as to take fully into account the requirements and operation habits of the different users.

### BACKGROUND OF THE INVENTION

1. Field of the invention

The present invention relates to a mouse with a direction-adjustable connecting wire, and more particularly to the mouse has a direction-adjustable connecting wire that makes the mouse that is easily and conveniently operated, i.e. the mouse has a better controllability.

2. Description of the Prior Art

A computer mouse is a hand-held, button-activated input device for desktop computers. When it is moved, it provides corresponding movement of a cursor on screen; with the flick of a wrist and the click of a button, an application can be launched, a function can be selected, text can be deleted or a line can be drawn. Both the mechanical and the optical ones have been popular for a long time.

Reference is made from FIG. 1 which is a perspective view of a mouse of the prior art. In existing technology, not only mechanical mouse but optical mouse, a connecting wire 12a for transmitting signals is fixedly connected to a housing 11a of the mouse 10a. And that, the connecting wire 12a can not be used to adjust the direction for the requirements and operation habits of the different users and the mouse 10a has bad controllability and inconvenient operation.

The inventor of the present invention recognizes the above shortage should be corrected and special effort has been paid to research this field. The present invention is presented with reasonable design and good effect to resolve the above problems.

### SUMMARY OF THE INVENTION

It is a primary object of the present invention to provide a mouse with direction-adjustable connecting wire, that a direction-adjustable connecting wires designed to make the mouse is easily and conveniently operated so as to take fully into account the requirements and operation habits of the different users.

For achieving the objective stated above, the mouse with direction-adjustable connecting wire of the present invention includes a housing; a connecting wire, one side thereof is embedded in the housing; and a wire-receiving groove is surrounded around the housing, and the connecting wires contained in the wire-receiving groove and passed the housing from the wire-receiving groove.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The above and further advantages of this invention may be better understood by referring to the following description, taken in conjunction with the accompanying drawings, in which:

FIG. 1 is a perspective view of a mouse of a prior art;

FIG. 2 is a perspective view of a preferred embodiment of the present invention;

FIG. 3 is a side view of the preferred embodiment of the present invention;

FIG. 4 is a top view of the preferred embodiment of the present invention;

FIG. 5 is a view of the preferred embodiment of the present invention; and

FIG. 6 is a perspective view of another embodiment of the present invention.

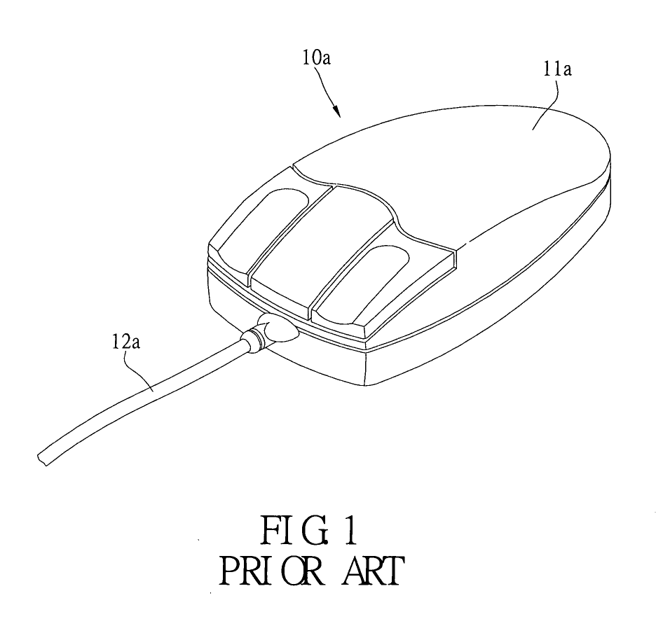

The drawings will be described further in connection with the following detailed description of the present invention.

### DETAILED DESCRIPTION OF THE PREFERRED EMBODIMENTS

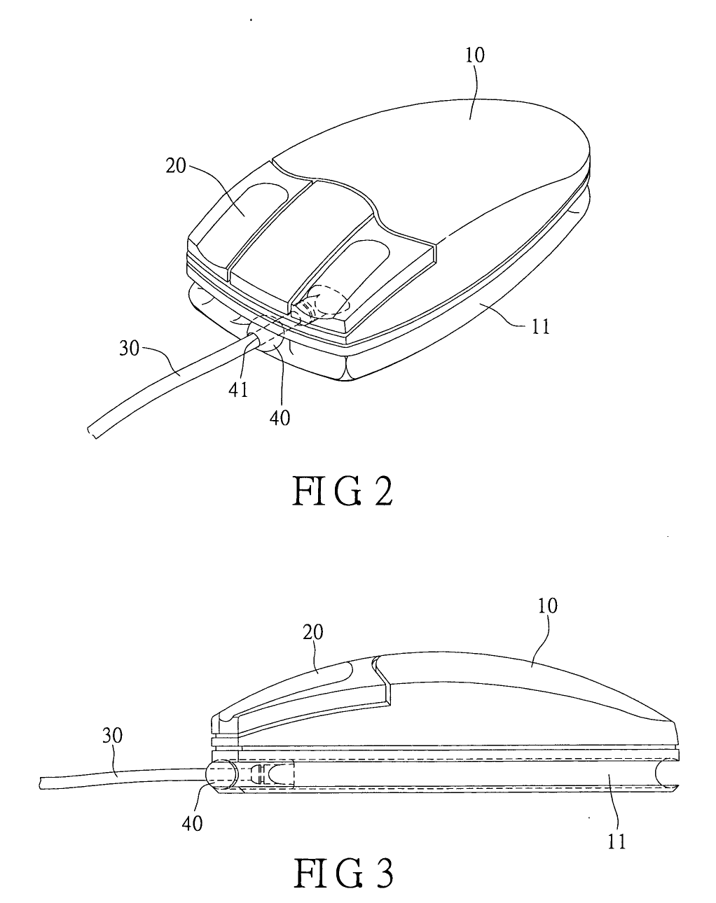

References are made from FIG. 2 to FIG. 5 that shows a preferred embodiment of a mouse with direction-adjustable connecting wire of the present invention. The mouse includes a housing 10, a cursor control unit (not shown), a plurality of mouse buttons 20, a connecting wire 30, and a trackball 40. The housing 10 is made of a plastic material as a hollow shell, and a circuit board (not shown) is designed in an inside thereof. A wire-receiving groove 11 is entirely or partially surrounded around a bottom of the housing 10, and the wire-receiving groove 11 has a C-shaped cross-section for containing the trackball 40. An outside of the wire-receiving groove 11 is a mouth-opening shape, and the connecting wire 30 is contained in the wire-receiving groove 11 via the outside mouth and passed the housing 10 from the wire-receiving groove 11.

The cursor control unit is electrically connected and installed on the circuit board, and the cursor control unit is exposed to the bottom of the housing 10 for controlling movement direction and distance of a mouse cursor.

The mouse buttons 20 are installed on the housing 10 and electrically connected to the circuit board for executing menu commands, selecting texts or graphics, clicking dialog box buttons, rolling up and down, displaying popup menu, and so on, while the mouse buttons 20 are clicked. In addition, a mouse wheel (not shown) is also installed for scrolling the windows.

One side of the connecting wire 30 is embedded in the housing 10 and electrically connected on the circuit board of the housing 1, and the other side of the connecting wire 30 has a plug (not shown) for connecting to a computer host so as to transmit the signals between the mouse and the computer host by the connecting wire 30.

The trackball 40 is installed in the wire-receiving groove 11 and movably contained therein. A wire-passing hole 41 is formed in a center of the trackball 40, and one side of connecting wire 30 is passed through the trackball 40 via the wire-passing hole 41 and into the housing 10 so that one side of the connecting wire 30 is electrically connected with the circuit board and the other side thereof is passed through the trackball 40 and is passed the housing 10 from the wire-receiving groove 11 to connect with the computer host.

In this embodiment, the trackball 40 is movably installed in the wire-receiving groove 11 of the housing 10 without falling out the housing 10 and make the connecting wire 30 be passed through the trackball 40 is contained in the wire-receiving groove 11 so as to adjust the connecting wire 30 in different outlet directions due to the trackball 40 installed in different locations of the wire-receiving groove 11.

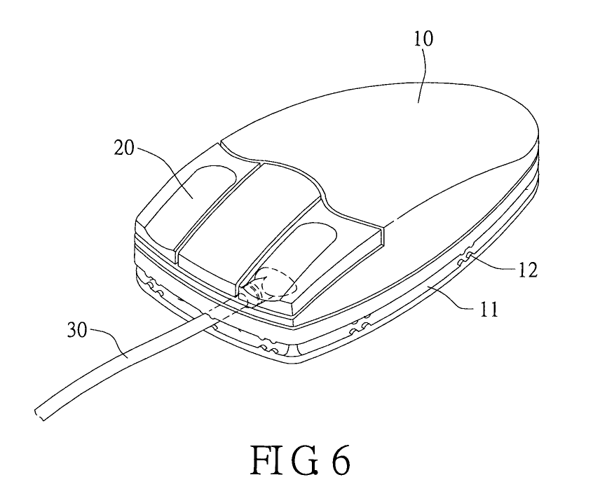

Reference is made from FIG. 6 which is a perspective view of another embodiment of the present invention. The wire-receiving groove 11 has a plurality of claws 12 are correspondingly protruded on both an upper end and an lower end of a inner wall of an outside of the wire-receiving groove 11 for fixing the connecting wire 30 in the wire-receiving groove 11 and positing a outlet direction of the connecting wire 30 so that the connecting wire 30 is passed through from different locations where the claws 12 are disposed to the housing 10.

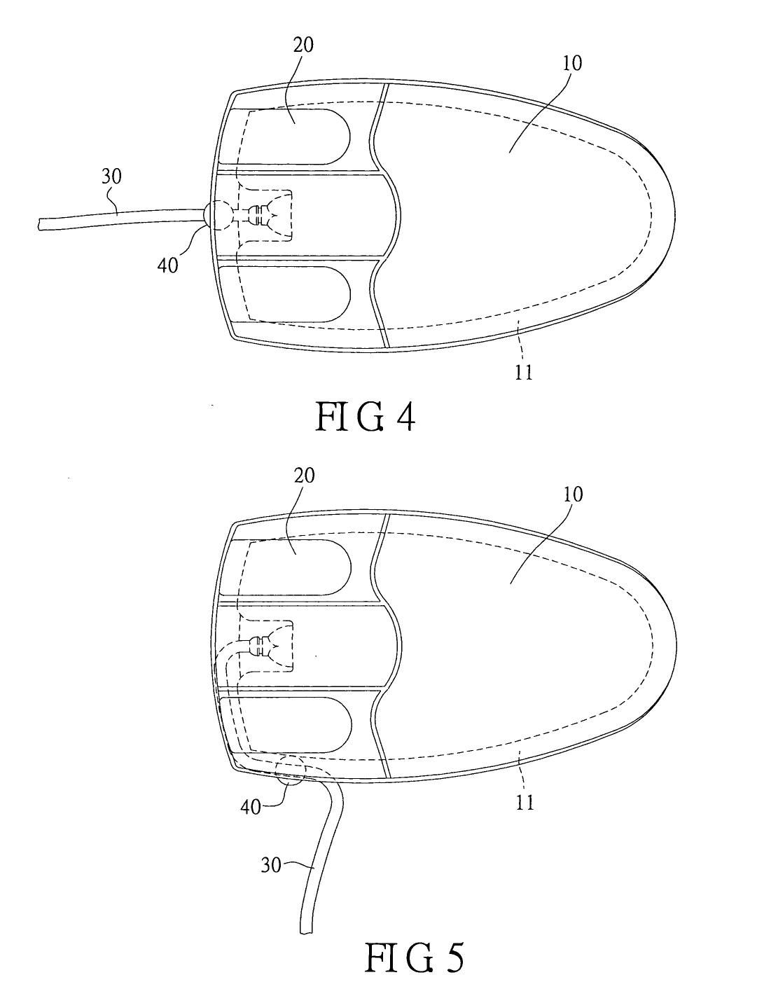

Therefore, the connecting wire 30 is designed (shown in FIG. 4 and FIG. 5) in different outlet directions such as the front end, left side, right side, rear end, or other directions of the mouse so that the mouse is easily and conveniently operated to take fully into account the requirements and operation habits of the different users.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A mouse with direction-adjustable connecting wire, comprising:
a housing;
a connecting wire, having one end embedded in the housing; and
a wire-receiving groove surrounded around the housing, and the connecting wire being contained in the wire-receiving groove and passed the housing from the wire-receiving groove.

2. The mouse with direction-adjustable connecting wire as in claim 1, wherein the wire-receiving groove is disposed in a bottom of the housing, and an outside of the wire-receiving groove is a mouth-opening shape.

3. The mouse with direction-adjustable connecting wire as in claim 1, wherein the wire-receiving groove has a movable trackball in an inside thereof, and the trackball has a wire-passing hole in a center thereof and the connecting wires passed through the trackball via the wire-passing hole.

4. The mouse with direction-adjustable connecting wire as in claim 1, wherein the wire-receiving groove has a plurality of claws are correspondingly protruded on both an upper end and an lower end of a inner wall of an outside of the wire-receiving groove for fixing the connecting wiren the wire-receiving groove and positing a outlet direction of the connecting wire.

5. The mouse with direction-adjustable connecting wire as in claim 1, wherein the wire-receiving groove is entirely or partially surrounded around the housing.
